(19) United States
(12) Patent Application Publication
(10) Pub. No.: US 2024/0329900 A1
(43) Pub. Date: Oct. 3, 2024

(54) AUGMENTED REALITY CAPTURE OF CUSTOMIZED CONTENT FOR PRINT-ON-DEMAND PRODUCTS

(71) Applicant: HALLMARK CARDS, INCORPORATED, KANSAS CITY, MO (US)

(72) Inventors: JENNIFER GARBOS, KANSAS CITY, MO (US); STEPHANIE YOUNG, KANSAS CITY, MO (US); MARLEE HALE, KANSAS CITY, MO (US); ALISON ERICKSON, KANSAS CITY, MO (US)

(21) Appl. No.: 18/621,899

(22) Filed: Mar. 29, 2024

Related U.S. Application Data
(60) Provisional application No. 63/455,380, filed on Mar. 29, 2023.

(51) Int. Cl. G06F 3/12; G06T 11/00

(52) U.S. Cl. CPC G06F 3/1256; G06F 3/1208; G06F 3/1242; G06F 3/1288; G06T 11/00; G06T 2200/24

(57) ABSTRACT

A system and method for customizing print-on-demand products is disclosed. A server system provides a user interface for rendering by an Internet-enabled application of a computing device, wherein the user interface provides an augmented reality (AR) preview screen that displays a digital representation of a customization panel of a product overlaid on a view of a real-world environment provided by a camera of the computing device. The AR preview screen enables a user to visualize customized content located in the real-world environment on the digital representation of the customization panel of the product and position the camera of the computing device to capture an image of the customized content. The server system receives the image of the customized content from the computing device, and generates a print file that causes printing of the customized content on the customization panel of the product.

### CROSS-REFERENCE TO RELATED APPLICATIONS

This application is based on and claims priority to U.S. Provisional Application Ser. No. 63/455,380, filed on Mar. 29, 2023, which is incorporated herein by reference in its entirety.

### BACKGROUND OF THE INVENTION

### 1. FIELD OF THE INVENTION

The present disclosure is generally related to print-on-demand products and, more particularly, to systems and methods that enable the printing of customized content on such products.

### 2. DESCRIPTION OF RELATED ART

Various systems and methods are used to customize greeting cards and other print-on-demand products. In some systems, a user utilizes a stylus to input a message to be printed on a greeting card. This input method is not ideal due to the poor appearance of text that has been written with a stylus. In other systems, a user types a message into a data input field displayed on a web page, and may also select the font type, font size, alignment, etc. for the text in the typed message. While this input method is relatively easy to use, it does not enable the user to customize the greeting card with a message written in the user's own handwriting. In yet other systems, a user uploads a photo of a handwritten message for placement within a print zone on the greeting card. A downside to this input method is that the uploaded photo may be out of scale in relation to the greeting card, e.g., the text of the handwritten message may appear too small when printed within the print zone on the greeting card. Thus, there remains a need in the art for improved technology that overcomes some or all of the drawbacks associated with existing systems for customizing greeting cards and other print-on-demand products and/or that offers other advantages compared to such existing systems.

### BRIEF SUMMARY OF THE INVENTION

The present invention is directed to systems and methods that utilize augmented reality (AR) technology to customize print-on-demand products, such as greeting cards, envelopes, gift tags, gift bags, wrapping paper, tissue paper, ornaments, soft goods, wall hangings, home décor, picture frames, clothing items, gift products, accessories, and any other products with a customizable and printable surface.

A user's computing device provides a user interface with an AR preview screen that displays virtual content overlaid on a view of a real-world environment provided by a camera of the computing device, i.e., the camera's active view. In some embodiments, the virtual content comprises a digital representation of a product's customization panel, such as the panel of a greeting card. The AR preview screen enables a user to visualize customized content located in the real-world environment (e.g., a message handwritten on paper) on the digital representation of the customization panel of the product. If necessary, the user can adjust the appearance (size, orientation, and/or placement) of the customized content on the digital representation of the customization panel simply by changing the position of the camera. As such, the user can position the camera to capture a desired image of the customized content. In some embodiments, an unwanted portion of the customized content (e.g., a coffee ring or lines on notebook paper) may be removed from the captured image. The captured image may then be used to generate a print file that causes printing of the customized content on the customization panel of the product. Alternatively, if the resolution of the captured image is low, the user may be prompted to capture a second higher resolution image of the customized content. In this case, the original captured image may be used to set the scale and placement of the second higher resolution image, which is used to generate the print file that causes printing of the customized content on the customization panel of the product.

The present invention overcomes many of the drawbacks of existing systems, including: (1) a user can write a message on a piece of paper using a standard writing instrument (e.g., a pen or pencil) to create a handwritten message in the user's own handwriting; (2) the user can preview and adjust the appearance of the handwritten message on the digital representation of the customization panel to ensure that the handwritten message is properly scaled to the customization panel; and (3) the customized product has an appearance that simulates the appearance of a product in which the user has handwritten a message directly on the product. Thus, the technology enables the creation of a customized product with qualities and characteristics that are superior to those of products created by existing systems.

Various embodiments of the present invention are described in detail below, or will be apparent to one skilled in the art based on the disclosure provided herein, or may be learned from the practice of the invention. It should be understood that the above brief summary of the invention is not intended to identify key features or essential components of the embodiments of the present invention, nor is it intended to be used as an aid in determining the scope of the claimed subject matter as set forth below.

### BRIEF DESCRIPTION OF THE DRAWINGS

A detailed description of various exemplary embodiments of the present invention is provided below with reference to the following drawings, in which:

FIG. 1 is a system block diagram of a greeting card customization system in accordance with one embodiment of the invention;

FIG. 2 is a block diagram of the central server shown in FIG. 1;

FIG. 3 is a block diagram of an exemplary smartphone that may be used as one of the computing devices shown in FIG. 1;

FIG. 4 is a process flow diagram of a greeting card ordering application executed by the central server shown in FIG. 1;

FIG. 5 is a process flow diagram of an AR preview application executed by the central server shown in FIG. 1;

FIGS. 6A-6C depict an AR preview screen provided on the smartphone shown in FIG. 2, on which is provided a single customization zone for the printing of customized content on a customization panel of a greeting card;

FIGS. 7A-7E depict an AR preview screen provided on the smartphone shown in FIG. 2, on which is provided two customization zones for the printing of customized content on a customization panel of a greeting card along with additional customization features; and

FIG. 8 depicts a greeting card with customized content printed on a customization panel of the card.

### DETAILED DESCRIPTION OF EXEMPLARY EMBODIMENTS

The present invention is directed to systems and methods for customizing print-on-demand products using augmented reality (AR) technology in which a digital representation of a customization panel of a product is overlaid on a camera's active view to enable a user to optimize the size, orientation, formatting and placement of the customized content captured by the camera for printing on the product. While the invention will be described in detail below with reference to various exemplary embodiments, it should be understood that the invention is not limited to the specific system configurations or methods of these embodiments. In addition, although the exemplary embodiments are described as embodying several different inventive features, one skilled in the art will appreciate that any one of these features could be implemented without the others in accordance with the invention.

In the present disclosure, references to “one embodiment,” “an embodiment,” “an exemplary embodiment,” or “embodiments” mean that the feature or features being described are included in at least one embodiment of the invention. Separate references to “one embodiment,” “an embodiment,” “an exemplary embodiment,” or “embodiments” in this disclosure do not necessarily refer to the same embodiment and are also not mutually exclusive unless so stated and/or except as will be readily apparent to one skilled in the art from the description. For example, a feature, structure, function, etc. described in one embodiment may also be included in other embodiments, but is not necessarily included. Thus, the present invention can include a variety of combinations and/or integrations of the embodiments described herein.

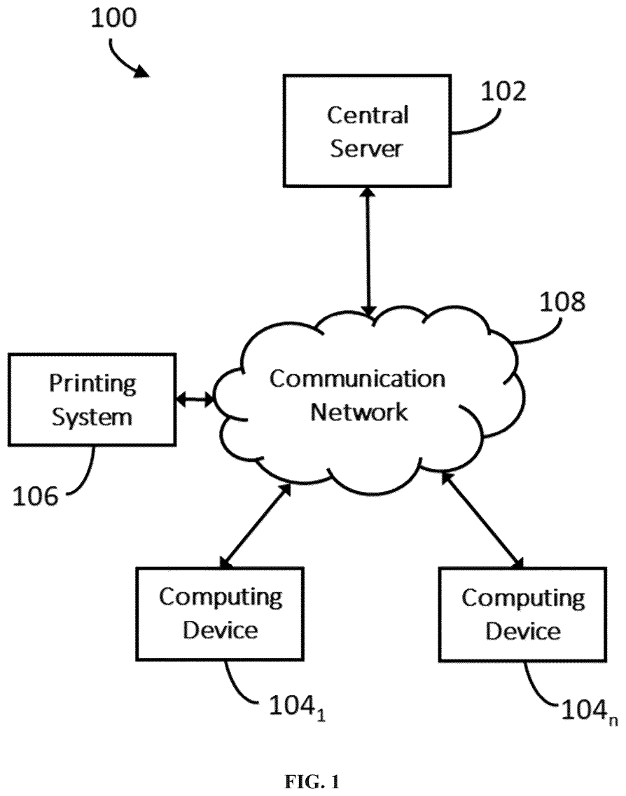

Referring to FIG. 1, one embodiment of a product customization system in accordance with the present invention is shown generally as reference number 100. System 100 will be described below in the context of a system for ordering customized greeting cards and their corresponding envelopes. Of course, it should be understood that the system may be used to customize a variety of other print-on-demand products, such as gift tags, gift bags, wrapping paper, tissue paper, ornaments, soft goods, wall hangings, home décor, picture frames, clothing items, gift products, accessories, and other products with a customizable surface.

Further, in other embodiments, the system may be used to create make-on-demand products in which customized content is added to a three-dimensional product blank (i.e., the print-on-demand product is also made on demand). In some instances, the make-on-demand production may include the creation of the three-dimensional product blank, such as a 3-D printed product blank, where the product blank is produced to include at least one surface for receiving customized content, as facilitated by an AR customization system. In other aspects, a pre-manufactured product blank may be used to apply multiple instances of user content adjusted to fit within a particular surface area of the substrate, where such adjustments are done utilizing the AR customization system. For example, a product substrate having a first customization surface and a second customization surface may be indicated for customization. To ensure that the user content being applied to each individual customization surface is captured by the user with accuracy of placement and/or proportion, the user may utilize the AR customization system features to adapt, using the AR customization technology, the capture of a first item of content for the first customization surface, and adapt, using the AR customization technology, the capture of a second item of content for the second customization surface.

In further aspects, the make-on-demand system may include multiple customization surfaces that are populated with customized content based on utilizing the AR customization system. For example, in some aspects, a first surface of a customizable substrate may be oriented for the application of customized content, such as printing of content, where the customized content for applying to the first surface is adapted during product selection by the user utilizing the AR customization tool. In another aspect, a second surface of the customizable substrate may be oriented for the application of customized content, such as printing of content, where the customized content for applying to the second surface is adapted during product selection using the AR customization tool.

In some examples, the customized content may be printed directly onto a customization substrate surface at a proportion relative to the planar surface area of the customization substrate, based on the AR-adjustments made during capture of the customized content. In other aspects, the customized content may be printed indirectly onto a substrate covering, and the substrate covering may be subsequently applied to the corresponding customization substrate surface at a proportion relative to the planar surface area of the customization substrate. Accordingly, a first AR adjustment during capture of the customized content on a first customization substrate surface may be distinct from a second AR adjustment during capture of the customized content on a second customization substrate surface, based at least in part on the content of the captured content, the dimensions of the planar surface area, and a scale of the captured content image relative to the intended customized surface based on manipulation using the AR capture tool.

In some aspects, a customization process utilizing the AR customization tool could include identifying a product having a first surface for receiving customized content. The AR customization tool may be used to identify the content for addition to the first surface, and the user experience may include limitations that facilitate accurate capture of the content for customization. In some aspects, the content may not be “captured” by the camera on the user's device unless and until the AR capture preview depicts an accurate placement in context of the overall substrate surface. In other words, the customization process may include a first limited AR capture process that requires an accurate image capture prior to proceeding to a second limited AR capture process to identify content to apply to a second customization surface area. As such, in some aspects, the variable surfaces of the customizable substrate may be identified using the AR customization tool prior to capture of the customization content by the user, such that the content being captured by the user is received by the system once the AR preview depicts content that would accurately populate an identified substrate surface for customization. In other words, multiple sections on the same customizable substrate could receive customized content once the customized content for the first substrate surface is “AR-approved” and the subsequent surface area of the substrate is identified for capture of an appropriately scaled customization content. In other words, the first surface area may be populated with customized content captured using the AR preview tool upon visual confirmation that the content will fit on the first customization surface, and following such capture, the second surface area may be populated with customized content captured using the AR preview tool upon visual confirmation that the second instance of captured content will fit within the second customization surface. In some aspects, a second surface of a customizable substrate may be assigned captured content after a first instance of content is captured in context of a first surface using the AR preview system.

System 100 includes a number of network elements—i.e., a central server 102, a plurality of computing devices 104₁-104ₙ, and a printing system 106—which communicate with each other via a communication network 108. Communication network 108 may comprise any network or combination of networks capable of facilitating the exchange of data among the network elements of system 100. In some embodiments, communication network 108 enables communication in accordance with one or more cellular standards, such as the Long-Term Evolution (LTE) standard, the Universal Mobile Telecommunications System (UMTS) standard, and the like. In other embodiments, communication network 108 enables communication in accordance with the IEEE 802.3 protocol (e.g., Ethernet) and/or the IEEE 802.11 protocol (e.g., Wi-Fi). Of course, other types of networks may also be used within the scope of the present invention. It should be appreciated that communication network 108 will typically comprise the Internet so as to enable access to central server 102 by any Internet-enabled device.

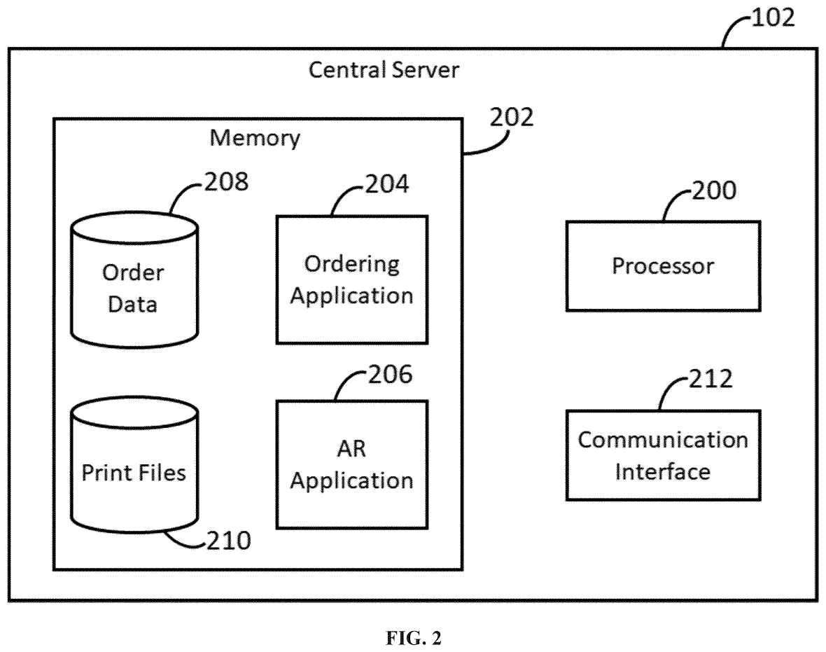

FIG. 2 is a block diagram illustrating an exemplary embodiment of central server 102 that may be accessed by computing devices 104₁-104ₙ to order customized greeting cards for delivery to card recipients. Central server 102 includes a processor 200 that is operatively connected to various hardware and software components, including a memory 202 and a communication interface 212. Processor 200 may comprise a multi-core processor, multiple processors, or some other type of processor, depending on the particular implementation.

Memory 202 may include any suitable combination of volatile memory (e.g., random-access memory (RAM)) and non-volatile memory (e.g. read-only memory (ROM), electrically erasable programmable read-only memory (EEPROM), or flash memory). Memory 202 stores various software applications, including greeting card ordering application 204 and augmented reality (AR) preview application 206, each of which comprises instructions that, when executed by processor 200, cause processor 200 to perform the methods described herein. Memory 202 also stores various databases, including an order database 208 and a print files database 210, each of which is configured to store data generated by the execution of these software applications.

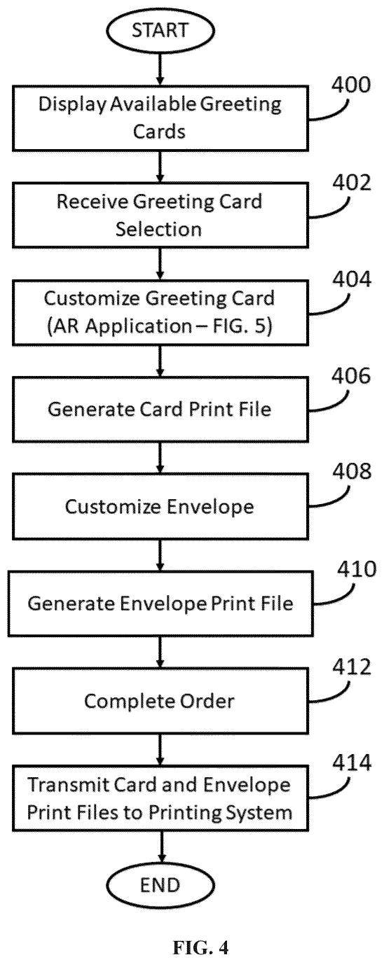

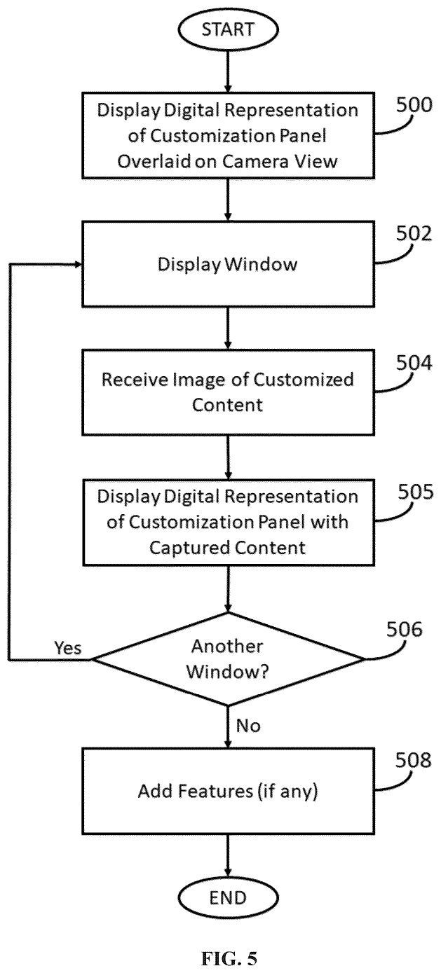

In general, greeting card ordering application 204 includes various modules that enable a user to select a fully customizable or pre-decorated greeting card from a plurality of available greeting cards, input customized content, and generate card and envelope print files that can be used by printing system 106 to print the customized content on the greeting card and envelope. In this embodiment, AR preview application 206 is called by greeting card ordering application 204 to enable a user to input at least a portion of the customized content using AR technology. The methods performed by greeting card ordering application 204 and AR preview application 206 will be described in greater detail below in connection with FIGS. 4 and 5.

Order database 208 stores a plurality of order records for the orders placed via card greeting card ordering application 204. The data elements for each order record may include a variety of different types of information, such as: (1) an order identifier; (2) information submitted by the user (e.g., customer information, billing information, shipping information, etc.); (3) known characteristics of the greeting card and envelope (e.g., the universal product code (UPC) of the card, the dimensions (length, width, and depth) of the card, the dimensions (length, width, and depth) of the envelope, the location of the card and envelope at a storage location, etc.); (4) postage information (e.g., the required postage or an indication of additional postage, a unique postage code, etc.); and (5) information related to printing the customized content on the greeting card and envelope (e.g., the file name of the card print file, the file name of the envelope print file, etc.). Of course, other data elements may also be stored in order database 208 in accordance with the invention.

Print files database 210 stores a card print file and an envelope print file for each of the orders placed via greeting card ordering application 204. In this embodiment and as noted above, the file names of the card and envelope print files are stored as data elements in order database 208 so that the print files can be associated with the appropriate order record. Of course, other means for storing the print files may also be used in accordance with the present invention.

Communication interface 212 may be any interface that enables communication between central server 102 and other network elements (including computing devices 104₁-104ₙ and printing system 106) via communication network 108. In some embodiments, communication interface 212 comprises a network interface card (NIC), an integrated network interface, and/or any other interfaces for connecting central server 102 to other network elements and/or communication networks. Such connections can include a wired connection or a wireless connection.

It should be understood that central server 102 may comprise a single server or any number and combination of web servers, application servers, database servers, file servers, and the like, which are either co-located in the same geographic location or located in different geographic locations and connected to each other via communication network 108. For example, greeting card ordering application 204 and/or AR preview application 206 could be stored on one or more application servers that may be accessed via communication network 108. Further, all or a portion of the data contained in order database 208 and/or print files database 210 could be stored on one or more database servers or file servers that may be accessed via communication network 108. Thus, the system may be implemented with any number and combination of servers that are either co-located or geographically dispersed.

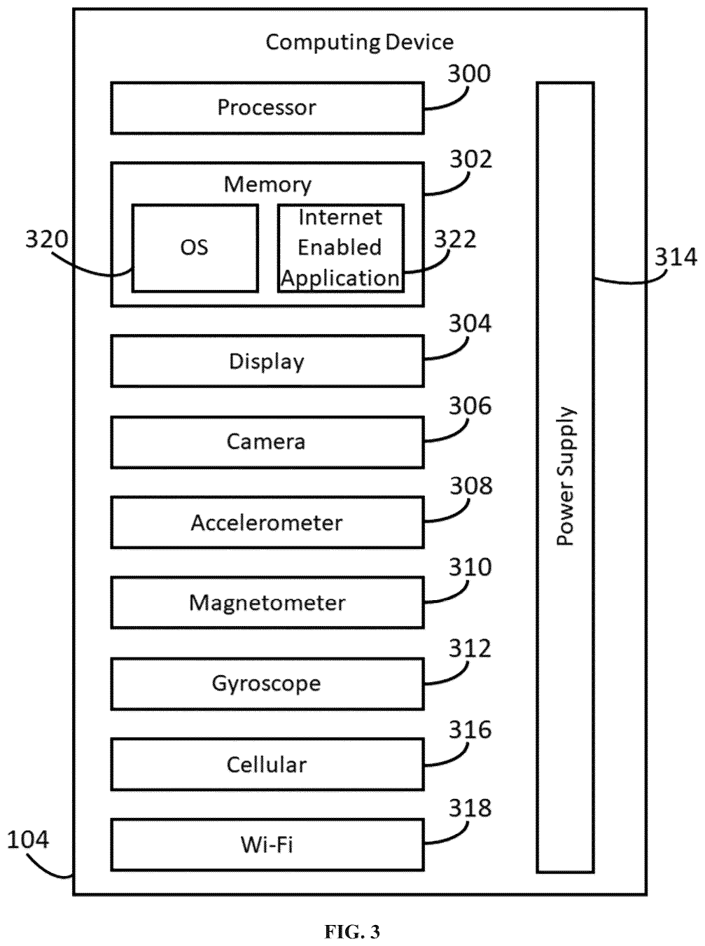

FIG. 3 is a block diagram illustrating an exemplary embodiment of a computing device 104 that may be used as one of computing devices 104₁-104ₙ to order customized greeting cards via access to central server 102. Computing device 104 may comprise a smartphone, a personal computing tablet, a personal computer, a laptop computer, smart glasses, a virtual reality head set, or any other computing device that is capable of communication with central server 102 via communication network 108.

In this embodiment, computing device 104 comprises a smartphone with a processor 300 that is operatively connected to various hardware and software components, including a memory 302, a display 304, a camera 306, an accelerometer 308, a magnetometer 310, a gyroscope 312, a power supply 314, and a wireless communication subsystem that includes a cellular transceiver 316 and a Wi-Fi transceiver 318.

Processor 300 may comprise a central processing unit (CPU), a multi-core processor, multiple processors, or some other type of processor, depending on the particular implementation. Processor 300 is operatively connected to memory 302, which may comprise any suitable combination of volatile memory (e.g., random-access memory (RAM)) and non-volatile memory (e.g. read-only memory (ROM), electrically erasable programmable read-only memory (EEPROM), or flash memory).

Memory 302 stores an operating system 320 and an Internet-enabled application

322. Internet-enabled application 322 may comprise a web browser, as is known in the art, or an application this is downloaded over communication network 108 and installed on computing device 104. As described in greater detail below, Internet-enabled application 322 sends requests to central server 102, and central server 102 responds by providing data that enables Internet-enabled application 322 to display various user interfaces on display 304 of computing device 104. Central server 102 may communicate with computing device 104 via Hypertext Transfer Protocol (HTTP) (e.g., HTTP/1.0, HTTP/1.1 plus, HTTP/2, or HTTP/3), Hypertext Transfer Protocol Secure (HTTPS), or any other network protocol used to distribute data and web pages.

Display 304 comprises a touch screen display configured to provide a graphical user interface that enables a user to perform a plurality of operations, as described herein. Exemplary displays include, but are not limited to, a liquid crystal display (LCD), an organic light emitting diode (OLED), an active matrix organic light emitting diode (AMOLED), and the like. Of course, other types of displays may be used in accordance with the present invention.

Camera 306 comprises one or more built-in digital cameras configured to output a camera feed of the real-world environment within the camera's field of view. Camera 306 is controlled by a camera application stored in memory 302. The camera application provides a graphical user interface on display 304, which provides various control features including a touchscreen shutter button that may be selected to capture an image of the current real-world environment within the camera's field of view. A user can adjust the appearance of a target object within the camera's field of view in different ways. For example, the user can change the size of the target object by moving camera 306 closer to or further from the target object. The user can also change the size of the target object by changing the camera's zoom level, e.g., the user may use his/her fingers to pinch in or pinch out on display 304. The user can further change the orientation and/or placement of the target object by manipulating the position of the target object in relation to camera 306.

Accelerometer 308, magnetometer 310 and gyroscope 312 are provided to determine the position and orientation of computing device 104. Specifically, accelerometer 308 measures acceleration and detects changes in the position of computing device 104. Magnetometer 310 measures magnetic fields and detects the absolute orientation in space of computing device 104. Gyroscope 312 measures changes in orientation or rotational velocity of computing device 104. Of course, other types of sensors may also be used in accordance with the present invention.

Power supply 314 is provided to supply power to the components of computing device 104. In this embodiment, power supply 314 comprises a rechargeable battery. Of course, other types of power sources may also be used in accordance with the present invention.

Cellular transceiver 316 and Wi-Fi transceiver 318 each enables long-range communication with central server 102. Cellular transceiver 316 is configured to enable communication with central server 102 in accordance with a cellular protocol, such as those that operate using the Long-Term Evolution (LTE) standard, the Universal Mobile Telecommunications System (UMTS) standard, and the like. Wi-Fi transceiver 318 is configured to enable communication with a local Wi-Fi network in accordance with the IEEE 802.11 protocol, wherein the local Wi-Fi network enables communication with central server 102. Of course, other types of communication interfaces may also be used in accordance with the present invention.

It should be understood that each of computing devices 104₁-104ₙ may not include all of the components shown in FIG. 3 and/or may include additional components that are not shown in FIG. 3. For example, a personal computer may be used as one of computing devices 104₁-104ₙ, which does not include a built-in digital camera and may instead be connected to an external camera. Thus, while the smartphone shown in FIG. 3 is well-suited to implement the present invention, the invention is not so limited and may be implemented using a variety of different types of computing devices.

Referring to FIG. 4, an exemplary method of ordering a customized greeting card that may be performed by central server 102 via the execution of greeting card ordering application 204 in accordance with one embodiment of the present invention is described with reference to steps 400-414.

In step 400, Internet-enabled application 322 of computing device 104 initiates communication with central server 102 by making a request for server access, e.g., a user may enter a specified network address such as a Uniform Resource Locator (URL) in a web browser. Central server 102 responds by providing a user interface—i.e., a browse page—for rendering by Internet-enabled application 322 on display 304 of computing device 104. The browse page displays a plurality of greeting card images associated with a plurality of greeting cards that are available for purchase. In some embodiments, each of the greeting card images displayed on the browse page is an image of the cover panel of the associated greeting card, although other types of images may also be used.

In some embodiments, the greeting card images are associated with pre-decorated greeting cards having different sizes and design formats—i.e., greeting cards with text, images, graphics, design elements or other decorative features pre-printed on and/or secured to at least one card panel. It can be appreciated that these pre-decorated greeting cards may be the same as those that are generally available for purchase at retail locations. The pre-decorated greeting cards may be customizable or non-customizable. For each customizable greeting card, it will be seen that a user may provide customized content using the augmented reality (AR) feature described below for printing within a customization zone on a customization panel of the pre-decorated greeting card. The customization panel may comprise, for example, the right inside panel of the pre-decorated greeting card, in which case the customized content may be a handwritten greeting and/or handwritten personalized message to be printed above and/or below the pre-printed content on the right inside panel.

In other embodiments, the greeting card images are associated with fully customizable greeting cards. In this case, the greeting card includes one or more placeholders for the addition of text, photos and/or graphic design elements. It will be seen that a user may enter text or upload a photo for printing within a customization zone (defined by a placeholder) on a customization panel of the fully customizable greeting card. The placeholders may just be representational, wherein the greeting card actually allows for customization within the entire card panel. In other words, the placeholders may be moveable on the customization panel, added to the customization panel, or deleted from the customization panel completely. The customization panel may comprise, for example, the cover panel of the greeting card, an inside panel of the greeting card, or other card panels. It will be seen that a user may also provide a handwritten message to be printed on the greeting card. For example, after the user designs her card by adding photos, text boxes with typed messages and graphic design elements, she may choose to add a handwritten message using the augmented reality (AR) feature described below.

In step 402, central server 102 receives a greeting card selection from computing device 104, e.g., a user selects one of the greeting cards from the plurality of pre-decorated and fully customizable greeting cards presented on display 304 of computing device 104.

In step 404, central server 102 provides a user interface for rendering by Internet-enabled application 322 on display 304 of computing device 104, wherein the user interface enables the user to initiate an augmented reality (AR) mode to input customized content, such as a personalized, handwritten message to be printed on at least one card panel of the greeting card. Each card panel that may be customized by the user is referred to herein as a “customization panel” of the greeting card. For example, the customization panel of a pre-decorated greeting card may be the right inside panel of the greeting card. However, a fully customizable card may have several customization panels, such as the front cover panel, the right inside panel, etc. Each customization panel includes one or more customization zones for placement of customized card content, wherein the size and position of each customization zone will vary between greeting cards. AR preview application 206 enables a user to input customized card content for placement in each customization zone, as described in greater detail below in connection with FIG. 5.

In one embodiment, the size and position of each customization zone is determined by greeting card ordering application 204. For example, the user interface may display a window having a fixed size and position on the customization panel of the greeting card and the customized card content will be placed substantially in that window. If the greeting card includes pre-printed card content on the customization panel, the customization zone for the customized card content will preferably not overlap the pre-printed card content. Greeting card ordering application 204 may also allow the user to select the number of customization zones, e.g., a single customization zone for a “quick sign” option or two or more customization zones to enable the input of two or more different signatures at two different times.

In another embodiment, the size and position of each customization zone is configurable by the user. For example, the user interface may allow the user to configure the size and/or position of the window on the customization panel of the greeting card. If the greeting card includes pre-printed card content on the customization panel, the customization zone for the customized card content may be selected to overlap or not overlap the pre-printed card content. In many cases, the user may select a customization zone that is spaced below the pre-printed card content. However, if the customized card content comprises markings written by a child, the user may select a customization zone that results in the markings overlapping the pre-printed card content so as to give the card a child-like appearance. If the greeting card is fully customizable, the user may configure multiple customization zones for the placement of customized photos, text boxes with typed messages, and graphic design elements, as well as handwritten text that is added using the augmented reality (AR) feature described below.

In step 406, central server 102 generates a card print file that causes printing of the customized card content onto the greeting card. In some embodiments, generation of the card print file is based on the template for the ordered greeting card and the customized card content input by the user. In one embodiment, the greeting card template provides the dimensions of each customization panel of the greeting card, as well as the size and position of each customization zone for placement of customized card content on the customization panel. In another embodiment, the greeting card template provides positional reference points (instead of dimensions) to define the customization zone on the customization panel of the greeting card. In yet another embodiment, the card print file encompasses the entire greeting card design and is printed onto a blank greeting card template.

It should be noted that the template for the greeting card and the customized card content could alternatively become part of an intermediate file prior to generation of the card print file. For example, a captured image and the relative location of that image to the template may be stored in a “content” file that is modified/cleaned up to remove the background portion of the image so that only the intended content (e.g., the message written in pen) is retained. The modified file then becomes the card print file.

In step 408, central server 102 provides a user interface for rendering by Internet-enabled application 322 on display 304 of computing device 104, wherein the user interface enables the user to input customized envelope content to be printed on the front face of the envelope corresponding to the selected greeting card—i.e., the front face of the envelope is the “customization panel” of the envelope. The customized envelope content may comprise, for example, the name and address of the card recipient and optionally the name and address of the card sender. In one embodiment, the user may enter each name and address in data input fields displayed on one or more web pages. In another embodiment, the user may handwrite each name and address on a blank piece of paper and capture an image of the same using the AR preview application 206. It can be appreciated that the size and position of each customization zone for placement of customized envelope content on the customization panel of the envelope is determined based on the size of the envelope corresponding to the selected greeting card.

In step 410, central server 102 generates an envelope print file that causes printing of the customized envelope content on the customization panel of the envelope. In this embodiment, generation of the envelope print file is based on the template for the envelope, the customized envelope content input by the user, and optionally a unique postage code that is retrieved from order database 208 or a list of unique postage codes available for use by system 100 (in embodiments where a digital postage stamp is applied to the envelope). In one embodiment, the envelope template provides the dimensions of the customization panel (e.g., the front face) of the envelope, as well as the size and position of each customization zone for placement of customized envelope content on the customization panel. In another embodiment, the envelope template provides positional reference points (instead of dimensions) to define the customization zone on the customization panel of the envelope.

It should be noted that the template for the envelope and the customized envelope content could alternatively become part of an intermediate file prior to generation of the envelope print file. For example, a captured image and the relative location of that image to the template may be stored in a “content” file that is modified/cleaned up to remove the background portion of the image so that only the intended content (e.g., the name/address written in pen) is retained. The modified file then becomes the envelope print file.

In step 412, central server 102 provides a user interface for rendering by Internet-enabled application 322 on display 304 of computing device 104, wherein the user interface enables the user to place the order for the customized greeting card. To do so, the user may be required to enter customer information, billing information, shipping information, and other types of order information into various data input fields displayed on one or more web pages.

One skilled in the art will appreciate that the card and envelope print files generated in steps 406 and 410, respectively, may alternatively be generated after placement of the order in step 412.

In step 414, central server 102 transmits the card and envelope print files to printing system 106. Printing system 106 is configured to execute the card print file to print the customized card content (e.g., a personalized message) on the customization panel(s) of the greeting card and, similarly, execute the envelope print file to print the customized envelope content (e.g., the name and address of the card recipient and optionally the name and address of the card sender) on the customization panel of the envelope. A variety of different printing systems may be utilized in accordance with the present invention.

In some embodiments, printing system 106 comprises a conveyor-based system in which one or more printers are controlled by a printer control system. Upon the assignment of an order record (i.e., a print job) to the greeting card/envelope pair, the printer control system communicates with central server 102 via communication network 108 to retrieve the card and envelope print files associated with the order record. The printer control system uses Raster Image Processor (RIP) software to translate each of the card and envelope print files into their color layers for transmission to the one or more printers. The card print file is configured to drive the printing of the customized card content on the customization panel(s) of the pre-decorated greeting card during transport along a card conveyor and, similarly, the envelope print file is configured to drive the printing of the customized envelope content on the customization panel of the envelope during transport along an envelope conveyor.

In some embodiments, a single printer positioned above both the card conveyor and the envelope conveyor is used to print the customized card content and the customized envelope content on the greeting card and envelope, respectively. In this case, the relative speeds of the conveyors are controlled or adjusted prior to the printing process so that the greeting card and envelope reach the printer at substantially the same time. In other embodiments, a first printer positioned above the card conveyor is used to print the customized card content on the greeting card and a second printer positioned above the envelope conveyor is used to print the customized envelope content on the envelope. In this case, it is not required to control or adjust the relative speeds of the conveyors prior to the printing process.

A printing system that is suitable for use with the present invention is described in PCT Publication No. WO2022/147027A1 (PCT Application No. PCT/US2021/065365), entitled “Automated Greeting Card Conveyance System,” published Jul. 7, 2022 (filed Dec. 28, 2021), which is incorporated herein by reference in its entirety. Of course, it should be understood that the present invention is not limited to the use of conveyor-based printing systems and that other types of printing systems may be used to print customized content on print-on-demand products within the scope of the present invention.

Referring to FIG. 5, an exemplary method of enabling a user to input customized content that may be performed by central server 102 via the execution of AR preview application 206 in accordance with one embodiment of the present invention is described with reference to steps 500-508. It should be understood that the method of FIG. 5 is performed during step 404 of the greeting card ordering method shown in FIG. 4.

In step 500, central server 102 provides a user interface for rendering by Internet-enabled application 322 on display 304 of computing device 104, wherein the user interface provides an AR preview screen that displays a digital representation of a customization panel of a greeting card overlaid on a view of a real-world environment provided by camera 306 of computing device 104 (i.e., the active camera view). For a pre-decorated greeting card, the digital representation of the customization panel may comprise the pre-printed content on the right inside panel of the greeting card. For a fully customizable greeting card, the digital overlay may comprise the photos, typed messages and/or graphic design elements added by the user while designing the cover panel or right inside panel of the greeting card. In some embodiments, the digital representation of the customization panel may have a translucent appearance.

The AR preview screen enables a user to visualize customized content located in the real-world environment on the digital representation of the customization panel. The customized content may comprise, for example, a personalized message handwritten by a user on a blank piece of paper. The user may write the personalized message prior to performance of step 500, or, the user may preview the blank piece of paper while writing the personalized message (in which case the AR preview screen provides a live view of the writing). It should be understood that the handwritten message is preferably representative of how the user would write on an actual greeting card and may include, for example, underlining of certain words, arrows to certain words, etc. It should also be noted that the handwritten text is written without any reference to the dimensions of the customization panel. Of course, other types of customized content may also be used, such as artwork, a photograph, a sticker, an arrangement of physical object(s), or even subject(s) of a photo shoot.

In step 502, the AR preview screen displays a window representative of a customization zone on the customization panel of the greeting card. The window may be presented so as to blink or otherwise direct the user's attention to the window. The window serves as a guide to enable the user to position the customized content substantially within the window—i.e., the user aligns the window over the customized content to be captured. The user can adjust the appearance (size, orientation and/or placement) of the customized content on the digital representation of the customization panel in different ways. For example, the user can change the size of the customized content by moving camera 306 closer to or further from the customized content. The user can also change the size of the customized content by changing the zoom level of camera 306, e.g., the user may use his/her fingers to pinch in or pinch out on display 304. The user can further change the orientation and/or placement of the customized content by manipulating the position of the customized content in relation to camera 306.

In some embodiments, the AR preview screen requires the customized content to be positioned entirely within the window. The color of the window on the AR preview screen may change if the customized content exceeds the window so as to alert the user to reduce the size of the customized content.

In other embodiments, the AR preview screen permits the user to override the customization zone rules of the greeting card. For example, the AR preview screen may require the customized content to be positioned substantially within the window, while allowing a portion of the customized content to exceed the window. As used herein, the customized content is positioned “substantially” within the window if the customized content does not exceed the window by more than a predetermined distance. As another example, the AR preview screen may allow a portion of the customized content to be positioned outside the window provided that the customized content is positioned on the customization panel and does not overlap the pre-printed content on the customization panel. Of course, other examples will be apparent to one skilled in the art.

In step 504, the user causes camera 306 to capture the desired image of the customized content, e.g., the image in which the customized content has an appearance that simulates the appearance of the user's message if handwritten directly on the greeting card. In some embodiments, the user causes camera 306 to capture the image by selecting the touchscreen shutter button on display 304 or via any other image capture means known in the art. Computing device 104 then sends the captured image to central server 104 and, in step 505, the AR preview screen is updated to show the captured image rendered on the digital representation of the customization panel at the designated position.

In some embodiments, a visual cue is provided if the captured image does not have sufficient image quality. Further, in some embodiments, central server 104 automatically eliminates objects in the captured image that are not desired to be printed on the greeting card. For example, a user may handwrite a message on paper that includes guide lines. These guide lines may be identified as “background” and eliminated from the captured image so that only the handwritten text is printed on the greeting card. As another example, the captured image may include a portion of the pre-printed card content, which must be removed from the captured image prior to rendering on the digital representation of the customization panel.

In step 506, it is determined whether there is another window representative of another customization zone on the customization panel of greeting card. If there is another window, the method returns to step 502 whereby steps 502, 504 and 505 are repeated for this window. In some embodiments, the user can capture two or more images of two or more sections of the customized content for placement in different windows. In other embodiments, the user can digitally manipulate the captured image so as to parse the customized content into two or more sections for placement in different windows (wherein each section may be scaled as required). If there is not another window, the method proceeds to step 508.

In step 508, the AR preview screen enables the user to add additional customization features, if desired. Examples of additional customization features include a content-specific sticker, a custom emoji, an avatar sticker, underlined or emphasized portions of the pre-printed card content, an arrow pointing to a portion of the pre-printed card content, a strikethrough that crosses out a portion of the pre-printed card content, one or more barcodes (e.g., a QR code), and the like. In some embodiments, digital content associated with the handwritten message may be subsequently added and linked to the physical print file created from the AR image capture, as described in U.S. Pat. No. 11,263,503, which is incorporated herein by reference in its entirety.

In some embodiments, a captured image may be edited in order to improve the appearance of the greeting card. For example, filters may be used to bend, enhance or otherwise modify a captured image in order to more accurately show how the customized content will appear on the greeting card. A secondary edit may also be performed in which a captured image is modified to remove speckles and other undesired characteristics, or in which the captured image is re-sized so that the customized content better fits within a customization zone. Other editing techniques will be apparent to one skilled in the art.

The method shown in FIG. 5 may be implemented using any augmented reality development software known in the art such as, for example, the ARKit® augmented reality platform available from Apple Inc. (“ARKit®”) or the ARCore™ augmented reality platform available from Google LLC (“ARCore™”). For example, ARKit® may be used to provide the following functionality on an iPhone® (or other iOS® compatible device):
1. The AR preview screen may be fed from a map of the area created through the phone's active camera view. For example, ARKit® may use Core Motion data to detect tabletops, floors, handwritten words on a writing surface or a blank writing surface on which the user handwrites the words-distinguishing between environmental images and the target image of the writing surface. Feature points on these surfaces and objects, along with internal phone sensors, enable computing of any changes in the phone's location.
2. ARKit® may enable real time modification of the digital image to accommodate handwritten words as they are written on the blank writing surface. For example, if the writing surface is blank at the start of the customization experience, the phone may register the writing surface as another environmental image. However, as marks are made on the writing surface, the contrast between images with the handwritten words and the writing surface registers so that the AR capture focuses on the added handwritten words (i.e., the marks of interest).
3. When the camera's shutter button is pressed, ARKit® may enable image capture of only the handwritten marks as detected through the AR environmental mapping. ARKit® may also adjust and accommodate for lighting conditions or shadows enabling the entire handwritten message to appear equally dark despite potential shadows or light beams.

Of course, one skilled in the art will understand that ARCore™ may be used to provide similar functionality on any Android™ compatible device. Other software development tools may also be used within the scope of the present invention.

In some embodiments, after the user has added the customized content, the user may be able to preview the customized greeting card, at scale, within the actual physical environment. This will allow the user to visualize the size of the greeting card and how large the handwritten words will appear on the greeting card. This may be accomplished using AR features similar to those described above—e.g., mapping to the physical environment and fixing the card dimensions to that environment.

Various examples will now be provided to illustrate the implementation of the method shown in FIG. 5.

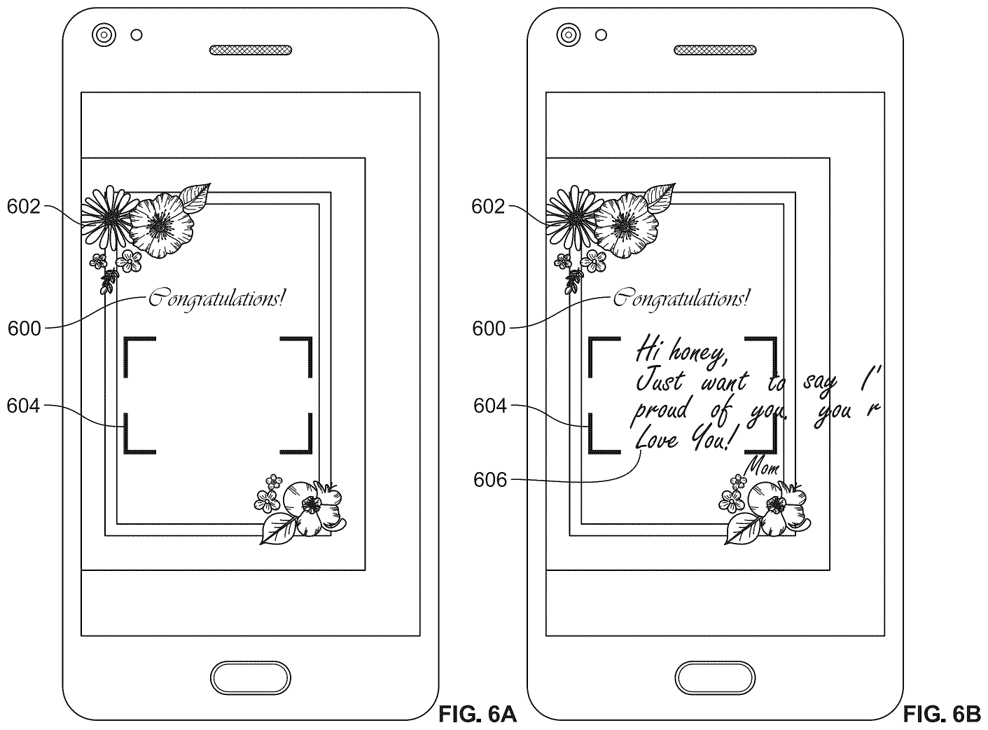

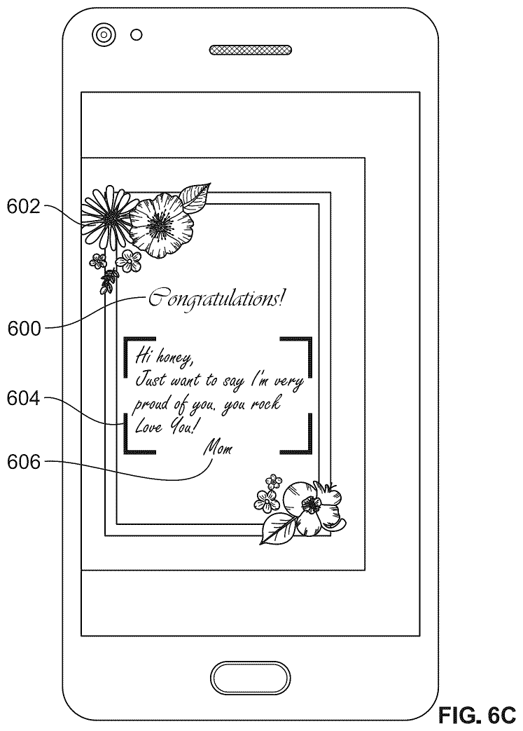

FIGS. 6A-6C depict an AR preview screen displayed on a smartphone in which the digital representation of the customization panel includes pre-printed text 600 and pre-printed design elements 602. As shown in FIG. 6A, a single window 604 representative of a single customization zone is provided for printing customized content on the customization panel of the greeting card. FIG. 6B shows the digital representation of the customization panel overlaid on customized content 606 provided within the active camera view. It can be seen that customized content 606 is large in size and placed too far to the right in relation to window 604. As such, the user can manipulate the smartphone to adjust the size and placement of the customized content 606 on the digital representation of the customization panel prior to image capture. FIG. 6C shows the digital representation of the customization panel overlaid on customized content 606 provided within the active camera view after such adjustment.

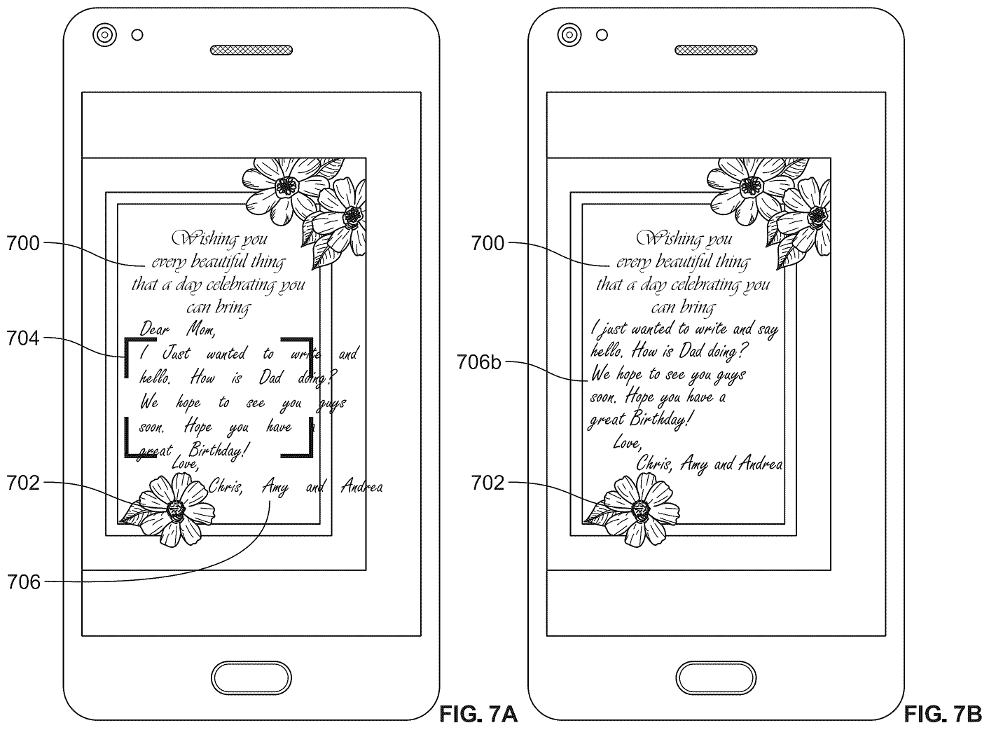

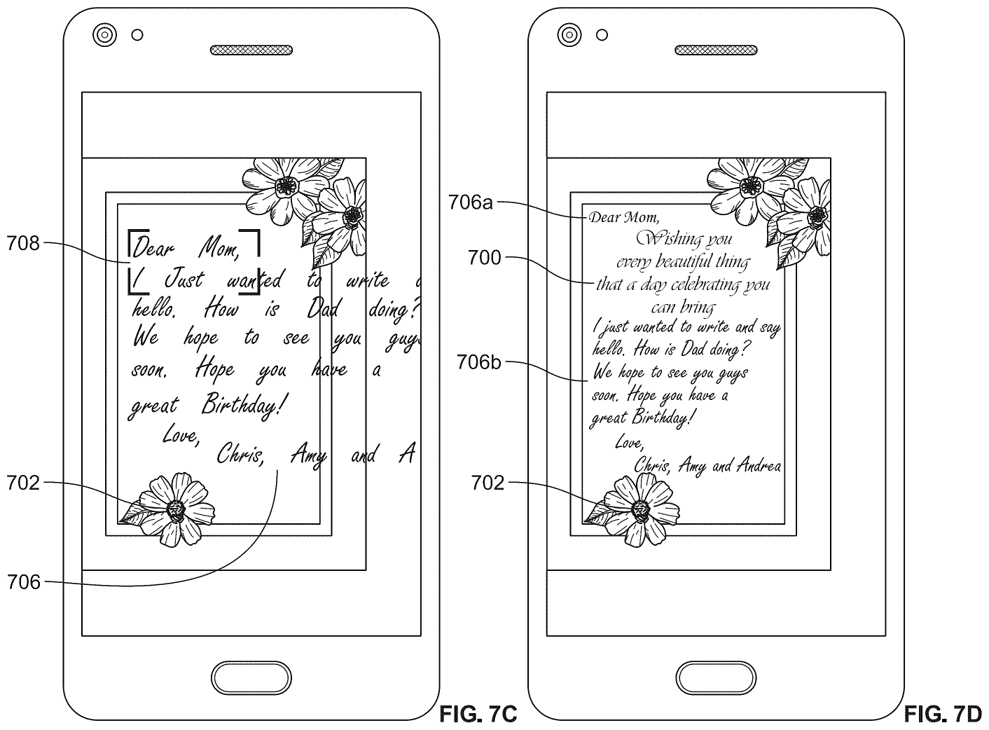

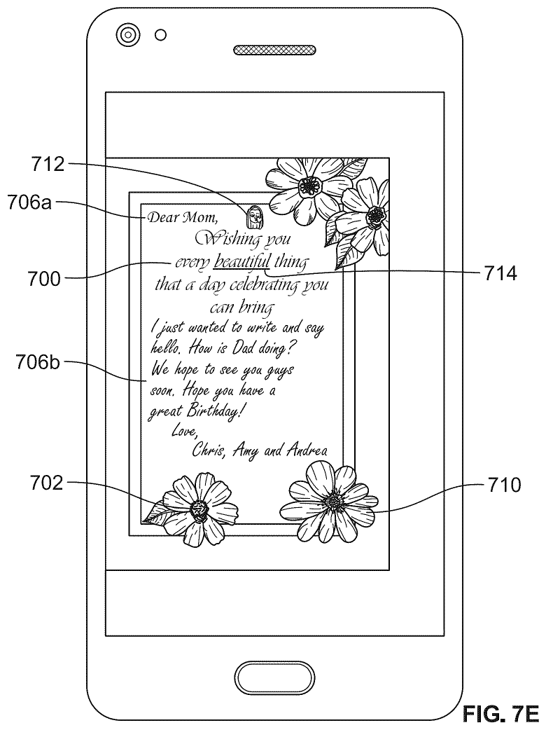

FIGS. 7A-7E depict an AR preview screen displayed on a smartphone in which the digital representation of the customization panel includes pre-printed text 700 and pre-printed design elements 702. In this case, the customized content 706 includes two portions—a salutation (i.e., “Dear Mom”) 706a followed by a personalized message 706b.

As shown in FIG. 7A, a first window 704 representative of a first customization zone is provided for printing customized content on the customization panel of the greeting card. As can be seen, the digital representation of the customization panel is overlaid on the customized content 706 provided within the active camera view. The personalized message 706b is large in size such that portions extend outside first window 704 (i.e., portions of personalized message 706b are positioned too far to the right and below first window 704). As such, the user can manipulate the smartphone to adjust the size and placement of the personalized message 706b on the digital representation of the customization panel prior to image capture. FIG. 7B shows the captured image of the personalized message 706b rendered on the digital representation of the customization panel.

As shown in FIG. 7C, a second window 708 representative of a second customization zone is provided for printing customized content on the customization panel of the greeting card. As can be seen, the digital representation of the customization panel is overlaid on the customized content 706 provided within the active camera view. The salutation 706a is positioned just a bit too high within second window 708. As such, the user can manipulate the smartphone to adjust the placement of the salutation 706a on the digital representation of the customization panel prior to image capture. FIG. 7D shows the captured image of the salutation 706a rendered on the digital representation of the customization panel.

FIG. 7E depicts the AR preview screen with the salutation 706a and personalized message 706b correctly positioned on the customization panel of the greeting card and reduced in scale where necessary to fit the entire handwritten message. Alternatively, the system could detect the difference in size between salutation 706a and personalized message 706b and output an automatic recommendation to reduce the scale of salutation 706a. In this example, the user has also added several additional customization features, including a content-specific sticker 710 (i.e., a flower that matches the other design elements 702 of the greeting card), an avatar sticker 712, and underlining 714 to emphasize the word “beautiful” of pre-printed card content 700. Of course, other customization features will be apparent to one skilled in the art.

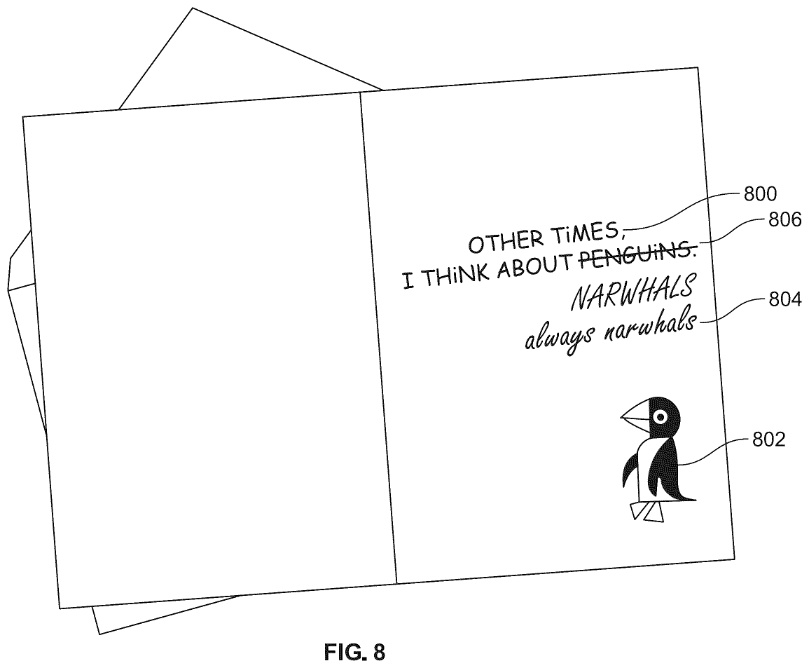

FIG. 8 depicts an exemplary greeting card with customized content printed on a customization panel of the card. In this example, the customization panel includes pre-printed text 800 and a pre-printed design element 802, and the customized content includes a handwritten message 804 and a strikethrough 806 of the word “penguins” of the pre-printed text 800. It should be understood that strikethrough 806 may have been part of the image of the customized content received in step 504, or, may have been added as a customization feature in step 508.

It should be understood that the method shown in FIG. 5 could also be used to input customized envelope content in accordance with the present invention. In this regard, the system may be used to capture customized card content, customized envelope content, or both. Other implementations will also be apparent to one skilled in the art, i.e., the method can be used to preview and capture customized content for printing on any printable surface of a product, regardless of whether the printable surface is flat (two-dimensional) or curved (three-dimensional).

### General Information

The description set forth above provides several exemplary embodiments of the inventive subject matter. Although each exemplary embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The use of any and all examples or exemplary language (e.g., “such as” or “for example”) provided with respect to certain embodiments is intended merely to better describe the invention and does not pose a limitation on the scope of the invention. No language in the description should be construed as indicating any non-claimed element essential to the practice of the invention.

The use of the terms “comprises,” “comprising,” or any other variation thereof, are intended to cover a non-exclusive inclusion, such that a system or method that comprises a list of elements does not include only those elements, but may include other elements not expressly listed or inherent to such system or method.

Finally, while the present invention has been described and illustrated hereinabove with reference to various exemplary embodiments, it should be understood that various modifications could be made to these embodiments without departing from the scope of the invention. Therefore, the present invention is not to be limited to the specific structural configurations or methodologies of the exemplary embodiments, except insofar as such limitations are included in the following claims.

What is claimed and desired to be secured by Letters Patent is as follows:

1. A system for customizing print-on-demand products, comprising:
a processor;
a memory in data communication with the processor, the memory storing at least one computer program comprising instructions that, when executed by the processor, cause the processor to perform a plurality of operations comprising:
providing a user interface for rendering by an Internet-enabled application of a computing device, wherein the user interface provides an augmented reality (AR) preview screen that displays a digital representation of a customization panel of a product overlaid on a view of a real-world environment provided by a camera of the computing device, wherein the AR preview screen enables a user to visualize customized content located in the real-world environment on the digital representation of the customization panel of the product and position the camera of the computing device to capture an image of the customized content;
receiving the image of the customized content from the computing device; and
generating a print file that causes printing of the customized content on the customization panel of the product.

2. The system of claim 1, wherein the product comprises one of a greeting card, an envelope, a gift tag, a gift bag, wrapping paper, tissue paper, an ornament, a soft good, a wall hanging, a home décor product, a picture frame, a clothing item, a gift product, or an accessory.

3. The system of claim 1, wherein the customized content comprises one of a handwritten message, an artwork, a photograph, a sticker, an arrangement of one or more physical objects, or one or more subjects of a photo shoot.

4. The system of claim 1, wherein the AR preview screen enables the user to adjust an appearance of the customized content on the digital representation of the customization panel of the product prior to capture of the image.

5. The system of claim 1, wherein the AR preview screen further displays a window representative of a customization zone on the customization panel of the product, wherein the AR preview screen enables the user to position the customized content substantially within the window.

6. The system of claim 1, wherein the AR preview screen further displays two or more windows representative of two or more customization zones on the customization panel of the product, wherein the AR preview screen enables the user to parse the customized content into two or more content sections and position the content sections substantially within the two or more windows.

7. The system of claim 1, wherein the operations further comprise transmitting the print file to a printing system, wherein the printing system is configured to execute the print file to print the customized content on the customization panel of the product.

8. The system of claim 1, wherein the operations further comprise adjusting an appearance of the customized content on the digital representation of the customization panel of the product after capture of the image.

9. The system of claim 1, wherein the AR preview screen further enables the user to add one or more customization features to the customization panel, wherein each of the customization features comprises one of a content-specific sticker, an emoji, an avatar sticker, or a handwritten mark.

10. The system of claim 9, wherein the product includes pre-printed content, and wherein the handwritten mark comprises one of an underline that emphasizes a portion of the pre-printed content, an arrow that points to a portion of the pre-printed card content, or a strikethrough that crosses out a portion of the pre-printed content.

11. A method for customizing print-on-demand products, comprising:
displaying a digital representation of a customization panel of a product overlaid on a view of a real-world environment provided by a camera of a computing device to enable a user to visualize customized content located in the real-world environment on the digital representation of the customization panel of the product and position the camera of the computing device to capture an image of the customized content;
receiving the image of the customized content from the computing device; and
generating a print file that causes printing of the customized content on the customization panel of the product.

12. A system for customizing print-on-demand products, comprising:
a server system configured to:
provide a user interface for rendering by an Internet-enabled application of a computing device, wherein the user interface provides an augmented reality (AR) preview that displays a digital representation of a customization panel of a product overlaid on a view of a real-world environment provided by a camera of the computing device, wherein the AR preview screen enables a user to visualize customized content located in the real-world environment on the digital representation of the customization panel of the product and position the camera of the computing device to capture an image of the customized content;
receive the image of the customized content from the computing device;
generate a print file that causes printing of the customized content on the customization panel of the product; and
a printing system configured to execute the print file to print the customized content on the customization panel of the product.

13. The system of claim 12, wherein the product comprises one of a greeting card, an envelope, a gift tag, a gift bag, wrapping paper, tissue paper, an ornament, a soft good, a wall hanging, a home décor product, a picture frame, a clothing item, a gift product, or an accessory.

14. The system of claim 12, wherein the customized content comprises one of a handwritten message, an artwork, a photograph, a sticker, an arrangement of one or more physical objects, or one or more subjects of a photo shoot.

15. The system of claim 12, wherein the AR preview screen enables the user to adjust an appearance of the customized content on the digital representation of the customization panel of the product prior to capture of the image.

16. The system of claim 12, wherein the AR preview screen further displays a window representative of a customization zone on the customization panel of the product, wherein the AR preview screen enables the user to position the customized content substantially within the window.

17. The system of claim 12, wherein the AR preview screen further displays two or more windows representative of two or more customization zones on the customization panel of the product, wherein the AR preview screen enables the user to parse the customized content into two or more content sections and position the content sections substantially within the two or more windows.

18. The system of claim 12, wherein the server system is further configured to adjust an appearance of the customized content on the digital representation of the customization panel of the product after capture of the image.

19. The system of claim 12, wherein the AR preview screen further enables the user to add one or more customization features to the customization panel, wherein each of the customization features comprises one of a content-specific sticker, an emoji, an avatar sticker, or a handwritten mark.

20. The system of claim 19, wherein the product includes pre-printed content, and wherein the handwritten mark comprises one of an underline that emphasizes a portion of the pre-printed content, an arrow that points to a portion of the pre-printed card content, or a strikethrough that crosses out a portion of the pre-printed content.
